(19) United States
(12) Patent Application Publication
(10) Pub. No.: US 2002/0126349 A1
(43) Pub. Date: Sep. 12, 2002

(54) Multiplexing information on multiple wavelengths in optical systems

(76) Inventor: Mohsen Sarraf, Rumson, NJ (US)

Correspondence Address: Docket Administrator (Rm. 3C-512), Lucent Technologies Inc., 600 Mountain Avenue, P.O. Box 636, Murray Hill, NJ, 07974-0636, US

(21) Appl. No.: 09/805,011

(22) Filed: Mar. 12, 2001

(51) Int. Cl. H04J 14/02; H04B 10/06

(52) U.S. Cl. 359/124; 359/189

(57) ABSTRACT

An apparatus comprises an optical Fourier transform element and a multiplexer. A wavelength division multiplexed (WDM) optical signal comprising M channels is applied to the optical Fourier transform element. The optical Fourier transform element spreads, or scatters, the information bits on each of the M channels across N wavelengths (or channels), where N≧M. The resulting N optical channels are applied to the multiplexer, which provides an optical WDM spread signal comprising N channels. Thus, the frequency content of the information bits of the original M channels are carried, or distributed, over the N wavelengths of the optical WDM spread signal.

### FIELD OF THE INVENTION

This invention relates generally to communications and, more particularly, to optical communications systems.

### BACKGROUND OF THE INVENTION

In an optical communications system that utilizes dense wavelength division multiplexing (DWDM), a DWDM signal is created by multiplexing several sequences (or streams) of information bits, e.g., M streams, on M different optical wavelengths (or channels). For example, a DWDM signal may be created by modulating each laser of an M laser array with an associated one of the M information streams and combining the M laser array output signals, where each laser produces light at a different wavelength. Thus, each stream of information is conveyed via a separate optical channel (i.e., by an optical signal having a particular wavelength).

Unfortunately, this mapping of an information stream to a particular wavelength has some drawbacks. For example, if a laser fails—the associated information stream is lost. Also, different wavelengths—and therefore, different information streams—may encounter different levels of impairments (e.g., signal strength degradation and spreading) on the transmission channel between a source node and a destination node. Thus, because of these impairments, one or more signal amplification and/or regeneration stages may be required depending on the distance between the source node and the destination node. This will of course add cost to the system.

### SUMMARY OF THE INVENTION

In accordance with the invention, the information conveyed by each of M channels of a multiplexed optical signal is spread among N different optical signals, each of the N optical signals having a different wavelength, where N≧M.

In an illustrative embodiment, an apparatus comprises an optical Fourier transform element and a multiplexer. A wavelength division multiplexed (WDM) optical signal comprising M channels is applied to the optical Fourier transform element. The optical Fourier transform element spreads, or scatters, the information bits on each of the M channels across N wavelengths (or channels), where N≧M. These N channels are not carrying newly ordered bits, but they are carrying N signals that when put back together at a corresponding receiver will reproduce the original M bit streams. The resulting N optical channels are applied to the multiplexer, which provides an optical WDM spread signal comprising N channels. Thus, the frequency content of the information bits of the original M channels are carried, or distributed, over the N wavelengths of the optical WDM spread signal.

In another illustrative embodiment, an apparatus comprises optical-electrical and electrical-optical converters, an electrical Fast Fourier transform (FFT) element and a multiplexer. A wavelength division multiplexed (WDM) optical signal comprising M channels is converted to the electrical domain, via the optical-electrical converter, and applied to the FFT element. The FFT element spreads, or scatters, the information bits on each of the M channels across N wavelengths (or channels), where N≧M. The resulting N channels are converted back to the optical domain, via the electrical-optical converter, and applied to the multiplexer, which provides an optical WDM spread signal comprising N channels. Thus, the frequency content of the information bits of the original M channels are carried, or distributed, over the N wavelengths of the optical WDM spread signal.

### BRIEF DESCRIPTION OF THE DRAWING

FIG. 1 shows an illustrative block diagram of a portion of a communications system embodying the principles of the invention;

FIG. 2 shows an illustrative embodiment in accordance with the principles of the invention;

FIG. 3 shows illustrative graphs with respect to the embodiment shown in FIG. 2; and

FIGS. 4-5 show other illustrative embodiments in accordance with the principles of the invention.

### DETAILED DESCRIPTION

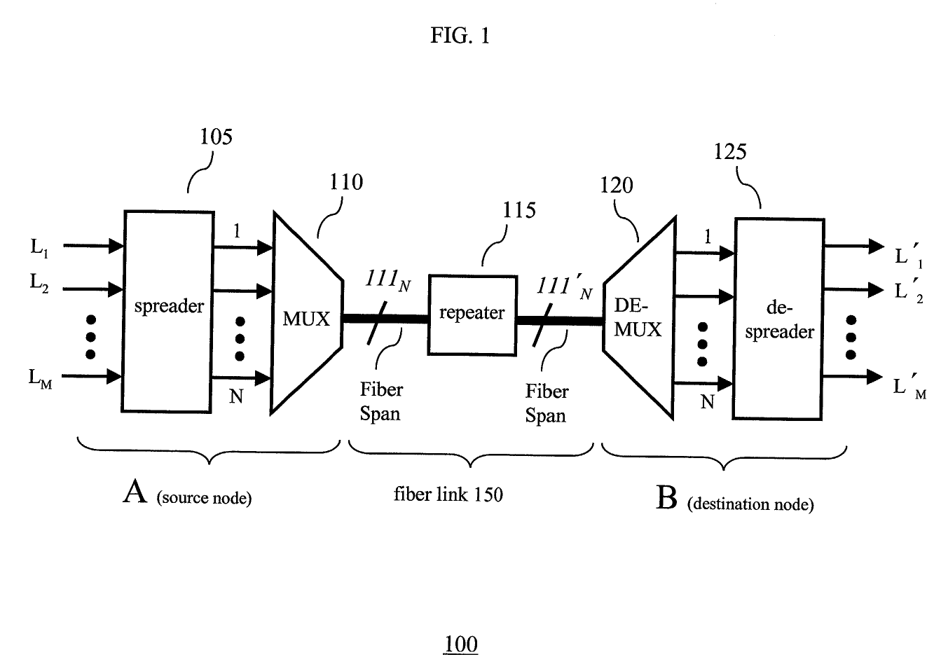

A portion of an illustrative communications system, 100, in accordance with the principles of the invention is shown in FIG. 1. Other than the inventive concept, the elements shown in FIG. 1 are well-known and will not be described in detail. For example, mux 100 is a wavelength division multiplexer, and de-mux 120 is a wavelength division demultiplexer, as known in the art. In addition, although shown as single block elements, some or all of these elements may be implemented using stored-program-control processors, memory, and/or appropriate interface cards (not shown). It should be noted that the term “node” as used herein refers to any communications equipment, illustrations of which are routers, gateways, etc. For the purposes of this example, it is assumed that portion 100 represents an optical-based system, i.e., all operations on signals are performed in the optical domain. (However, it should be realized that, although more expensive, the inventive concept can be equivalently constructed using elements in the electrical domain (described below).) Portion 100 comprises a source node A and a destination node (or sink node) B coupled via fiber link 150. The latter comprises fiber spans (e.g., optical fiber cabling) and a representative repeater 115 (i.e., there may be more than one). (It should be noted that a repeater is not required for the inventive concept and is shown in FIG. 1 merely for completeness.) Source node A receives M optical signals as represented by L₁, L₂, . . . L_{M}. Each optical signal conveys a different information stream at a different wavelength. (It should be noted that although shown as separate optical signals, an equivalent representation of the signals applied to source node A is a single wavelength division multiplexed (WDM) optical signal comprising M channels. In this case, either a demultiplexer (not shown) is added to source node A—to separate out the M channels or is assumed a part of spreader 105.) In accordance with the inventive concept, source node A spreads the information received from the M optical channels across N optical wavelengths, where N≧M, via spreader 105. Each of these new N optical channels conveys a portion of the M information streams. The N optical channels from spreader 105 are applied to multiplexer (mux) 110, which provides an optical WDM signal 111_{N} comprising N wavelengths (channels) to fiber link 150. At this point, the term “optical WDM spread signal” is used to differentiate between an optical WDM signal as represented by the signals applied to spreader 105 and an optical WDM signal constructed in accordance with the inventive concept. Optical VvDM spread signal 111_{N} transits fiber link 150, which—via repeater 115—amplifies/regenerates the signal (as represented by optical WDM spread signal 111′_{N}). Fiber link 150 provides optical WDM spread signal 111′_{N} to destination node B. The latter performs a complementary function to source node A to recover the original optical WDM signal comprising M channels. In particular, the received N channel optical WDM spread signal, 111′_{N}, is demultiplexed into N separate channels via demultiplexer (de-mux) 120. These N separate channels are applied to de-spreader 125, which “de-spreads” the information from the N channels back into M channels as represented by output optical signals L′₁, L′₂, L′_{M}. (As noted above, although shown as separate optical signals, an equivalent representation of the signals provided by destination node B is a single WDM optical signal comprising M channels. In this case, destination node B would further include a multiplexer (not shown) to form the optical WDM signal comprising M channels either as a part of despreader 125 or a separate element.)

As noted above, in accordance with the invention the information bits multiplexed on the M information bearing wavelengths are spread among N wavelengths. N must be larger or equal to M. This task is achieved by passing the M wavelengths through an operation, Γ, that is reversible by a reverse operation Γ⁻¹. In one embodiment, the operation F operates on the M incoming wavelengths (as represented by spreader 105) in the optical domain. In complementary fashion, the reversible operation, Γ⁻¹, is also performed in the optical domain. Thus, no electrical-to-optical or optical-to-electrical conversion is necessary. (However, as noted above, the inventive concept can be realized in the electrical domain as well.) The inventive concept can use any operation, Γ, that is reversible. One illustration of Γ is the Fourier Transform and, for Γ⁻¹, the corresponding Inverse Fourier Transform. (Other than the inventive concept, Fourier transform techniques are known in the art and will not be described herein. For example, in the wireless area, orthogonal frequency division multiplexing (OFDM) transmission utilizes Fourier transform techniques and in wired transmission, xDSL (e.g., asymmetric digital subscriber line) utilizes Fourier transform techniques in generating a discrete multi-tone (DMT) signal.)

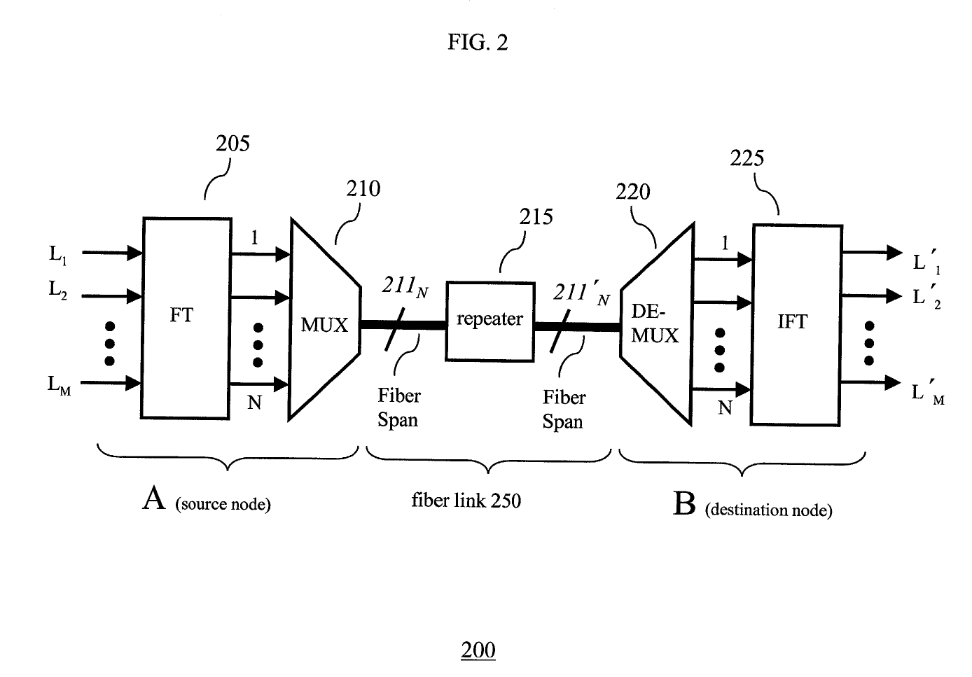

Turning to FIG. 2, an illustrative embodiment using a Fourier transform element is shown. FIG. 2 is similar to FIG. 1, showing source node A coupled to destination B via fiber link 250. Like FIG. 1, other than the inventive concept, the elements shown in FIG. 2 are well known and will not be described in detail. For simplicity, similar components between FIGS. 1 and 2 are not described again, e.g., fiber link 150 and fiber link 250. As shown in FIG. 2, source node A comprises optical Fourier transform (FT) element 205 and multiplexer (mux) 210. In a complementary fashion, destination node B comprises demulitplexer (de-mux) 220 and optical inverse Fourier transform (IFT) element 225. (It should be noted that Fourier processing of optical signals is known, e.g., Fourier Optics, Fourier-transform holograms, etc., (e.g., see Contemporary Optics, A. K. Ghatak and K. Thyagarajan, Plenum Press, 1978; Optics, W. H. A. Fincham and M. H. Freeman, Eighth Edition, Butrterworth & Co., 1974).)

An optical WDM signal comprising M channels is applied to optical FT element 205. The latter, scatters, or spreads, the information streams on each of the M channels onto N wavelengths. Note, if N>M, it is assumed that (N−M) “dark” bits are concatenated at the input to optical FT element 205. (In other words, although not shown, there are N−M unused input signals to optical FT element 205, these are assumed to be set to an equivalent bit value of “zero.”) Optical FT element 205 provides the N optical signals to mux 210, which generates optical WDM spread signal 211_{N} for transmission on fiber link 250. At the other end of fiber link 250, de-mux 220, of destination node B, receives optical WDM spread signal 211′_{N} (after amplification/regeneration, if any) and provides N optical signals to optical IFT element 225. The latter de-spreads, or recovers, the original M optical signals as represented by output optical signals L′₁, L′₂, . . . L′_{M}. (Again, those output channels from IFT element 225 corresponding to the above-mentioned “dark bits” are not used (nor shown in FIG. 2).

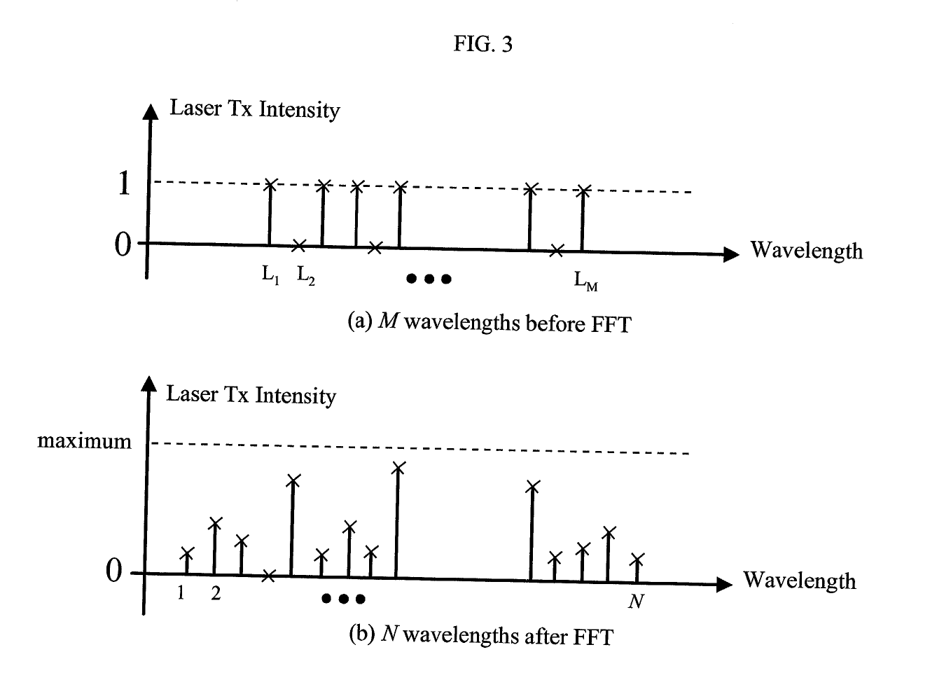

Attention should now be directed to FIG. 3, which further illustrates the inventive concept using a Fourier transform operation as described above. Graph (a) of FIG. 3 shows the illustrative optical WDM signal comprising M channels (L₁, L₂, . . . , L_{M}) as applied to source node A at a particular point in time—e.g., a symbol time, T. (A symbol time is the time it takes to transmit one symbol on each wavelength.) As noted earlier, each channel conveys a separate information stream. Illustratively, each of the M channels is modulated in a binary fashion. So, e.g., channel L₁ represents an optical signal at a particular wavelength conveying an information stream modulated at a particular point in time as either “ON,” as represented by a logical “1,” or “OFF,” as represented by a logical “0.” In graph (a), at this point in time, channel L₁ is illustrated as conveying a logical “1,” while channel L₂ is illustrated as conveying a logical “0,” etc. Once processed by source node A, the information conveyed in each of the M channels of the applied optical WDM signal is spread across another set of N optical signals, each at a different wavelength (or channel), where N≧M. The resulting optical WDM spread signal is illustrated in graph (b) of FIG. 3. Now, the M information streams are distributed across a new set of channels (1 to N) as illustrated in graph (b). Note, that in this approach instead of transmitting the actual information bearing digital ONEs and ZEROs, the Fourier transform, or frequency content, of the information bits of the M channels are now carried over N wavelengths as illustrated in graph (b). Each of the N wavelengths is now modulated by an intensity that is proportional to the Fourier transform of the M source wavelengths during a symbol time. Consequently, the N wavelengths are not carrying any digital ONEs and ZEROs, but they are carrying values every bit, or symbol, time that is not necessarily bound to be zero or one, and can even be a continuous range of values (up to a maximum value). As such, the N wavelengths carry a transformation of the input bits (Fourier transform content in this example) and not the actual bits on individual wavelengths, and that the information bits from each of the M wavelengths collectively contribute to the values carried on each of the N wavelengths. Therefore, during transmission of the optical WDM spread signal, any channel impairments subsequently affecting any of the N wavelengths will be spread among the M original source wavelengths at the receiver after the reverse operation (inverse Fourier transform in this example).

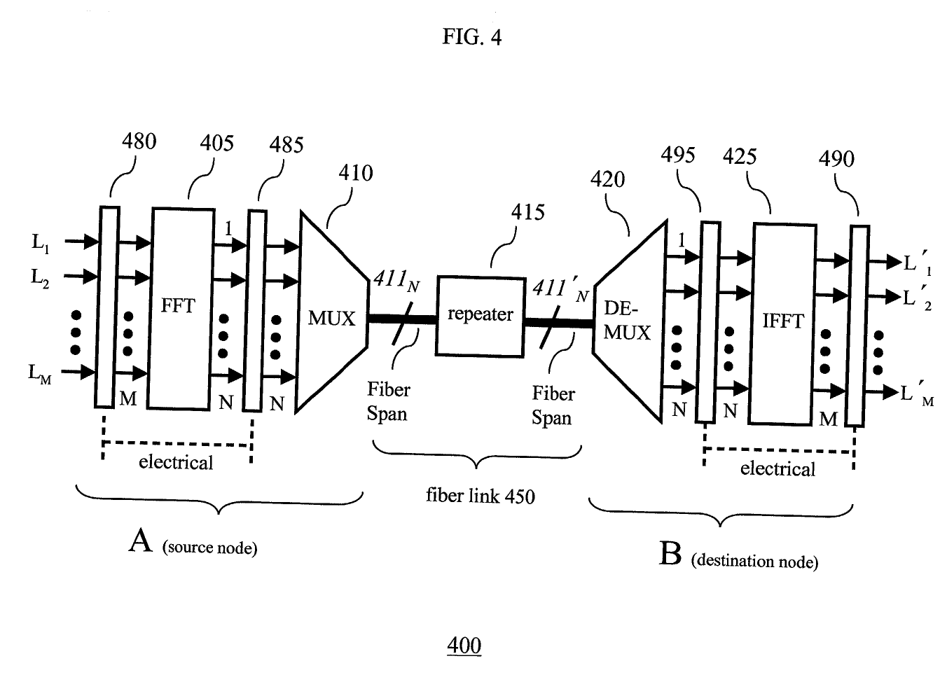

As noted above, although more expensive, the inventive concept can be equivalently constructed using elements in the electrical domain. (Also, it should be noted that such an optical-electrical-optical (O-E-O) system typically supports optical transmissions speeds that are lower (i.e., slower) than an all-optical system (e.g., as shown in FIG. 2) due to the processing in the electrical domain.) Such an illustrative embodiment is shown in FIG. 4, which is similar to FIG. 1, showing source node A coupled to destination B via fiber link 450. Like FIG. 1, other than the inventive concept, the elements shown in FIG. 4 are well known and will not be described in detail. For simplicity, similar components between FIGS. 1 and 4 are not described again, e.g., fiber link 150 and fiber link 450. As shown in FIG. 4, source node A comprises electrical fast Fourier transform (FFT) element 405 and multiplexer (mux) 410. In addition, source node A comprises optical-to-electrical interface 480 for converting the M received optical signals into the electrical domain, and electrical-to-optical interface 485 for converting the N signals from electrical FFT element 405 into the optical domain for processing by mux 410. In a complementary fashion, destination node B comprises demulitplexer (demux) 420 and electrical inverse FFT (IFFT) element 425. In addition, destination node B comprises optical-to-electrical interface 495 for converting the N received optical signals into the electrical domain, and electrical-to-optical interface 490 for converting the M signals from electrical IFFT element 425 back into the optical domain. (Again, as noted above, if N>M, there are N−M unused input signals to electrical FFT 405, which are illustratively set to zero values (the above-mentioned “dark bits”). Similarly, for electrical IFFT element 425 there a corresponding set of N-M output signals that are not used.)

An optical WDM signal comprising M channels is applied to optical-to-electrical interface 480, which converts the applied signals into the electrical domain for processing by electrical FFT element 405. The latter, scatters, or spreads, the information streams on each of the M channels onto N wavelengths. Electrical FFT element 405 provides the N optical signals to electrical-to-optical interface 485, which converts these signals back into the optical domain for processing by mux 410. The latter generates optical WDM spread signal 411_{N} for transmission on fiber link 450. At the other end of fiber link 450, de-mux 420, of destination node B, receives optical WDM spread signal 411′_{N} (after amplification/regeneration, if any) and provides N optical signals to optical-to-electrical interface 495 for converting the received signals into the electrical domain for processing by electrical IFFT element 425. The latter de-spreads, or recovers, the original M signals for application to electrical-to-optical interface 490, which provides the output optical signals L′₁, L′₂, . . . L′_{M}.

It should be noted that for more robust operation and to get better performance results it is desirable to have N>M. The larger N is compared to M, the better and more robustly the resulting system will perform. However, the larger N also requires more optical sources, e.g., lasers. Even though the inventive concepts allows these lasers to not be as accurate as those required to generate an optical WDM signal comprising M channels, this still adds cost. (Less accuracy is required because of the spreading of the information streams across the N channels in the resulting optical WDM spread signal.) Thus, the relationship of M to N is a design parameter and in each case N can be chosen differently for a given M as long as N≧M.

A number of benefits accrue from application of the inventive concept to a WDM-based optical system (DWDM or otherwise). For example, the spreading/de-spreading operation can be performed transparently to endpoints of an optical network. In addition, failure of an optical source at a particular one of the N wavelengths may degrade an optical WDM spread signal but does not completely eliminate transmission of any information stream (assuming use of error detection/recovery routines as known in the art (not described herein)). Also, communications channel impairments at one or more of the N wavelengths, e.g., pulse spreading, is now less of a concern since some signal degradation can now be tolerated. Thus, either cheaper optical sources, e.g., lasers, or fewer repeaters may be required in an optical communications system. Indeed, M information sources can now be carried via an optical WDM spread signal for a further distance than an optical WDM signal before resorting to amplification or regeneration at a given bit error rate performance. It should be noted that performance can be further improved by encoding the information bits multiplexed on the M source wavelengths prior to the Fourier transform (or any other reversible operator) operation and subsequently decoding them at the receiver after the inverse Fourier transform operation.

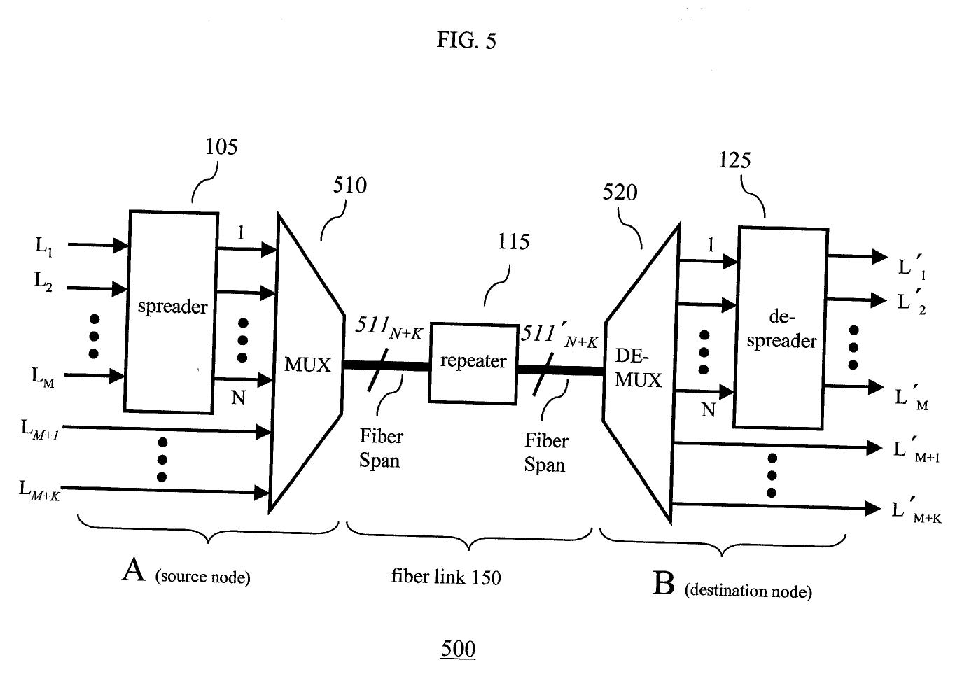

Other variations of the invention are possible, for example, a system can be designed with some wavelengths not using the above-described reversible operation. In this case an optical WDM signal comprising M channels is processed into a hybrid optical WDM signal—where the hybrid optical WDM signal further comprises an optical WDM signal comprising K channels and an optical WDM spread signal comprising N channels, where N≧(M−K), and K<M. Such a modification to the apparatus shown in FIG. 1 is illustrated in FIG. 5. As shown in FIG. 5, portion 500 shows a source node A comprising a mux 510 for forming the hybrid optical WDM signal 511_{N+K}. Conversely, destination node B comprises demux 520 for providing the N optical channels to despreader 125 and the other K optical channels.

The foregoing merely illustrates the principles of the invention and it will thus be appreciated that those skilled in the art will be able to devise numerous alternative arrangements which, although not explicitly described herein, embody the principles of the invention and are within its spirit and scope. For example, although the inventive concept was illustrated in the context of processing in the optical domain, equivalent operations can be performed in the electrical domain. Further, although the spreading/despreading operation was illustrated in the context of a Fourier transform, other methods may be used. In addition, although the inventive concept was described in the context of multiplexers and demultiplexers, the inventive concept is also applicable to other types of optical filtering devices such as, but not limited to, optical add/drop multiplexers, etc.

What is claimed:

1. A method for use in an optical communications system, the method comprising the steps of:
receiving M optical signals, each of the M signals representing information conveyed at a particular wavelength; and
spreading the information conveyed by each of the M optical signals among N optical signals, each of the N optical signals having a different wavelength, where N≧M.

2. The method of claim 1 wherein the spreading step includes the step of processing the M optical signals using a Fourier transform-based operation for spreading the information conveyed by each of the M optical signals among the N optical signals.

3. The method of claim 1 further comprising the step of multiplexing the N optical signals to provide a wavelength division multiplexed signal comprising at least the N channels.

4. The method of claim 1 further comprising the step of multiplexing the N optical signals, representing the information spread from the M optical channels, and K optical signals, each of the K signals representing information conveyed at a particular wavelength to provide a wavelength division multiplexed signal comprising N plus K channels.

5. The method of claim 1 wherein the spreading step includes the step of converting the M optical signals into M electrical signals.

6. The method of claim 5 wherein the spreading step includes the step of processing the M electrical signals using a Fourier transform-based operation for spreading the information conveyed by each of the M optical signals among N electrical signals, each of the N electrical signals corresponding to one of the N optical signals.

7. The method of claim 6 further comprising the steps of:
converting the N electrical signals into the N optical signals; and
multiplexing the N optical signals to provide a wavelength division multiplexed signal comprising N channels.

8. Apparatus for use in an optical communications system, the apparatus comprising:
a spreading element for distributing information conveyed by each of M optical channels among N optical channels, each of the N optical channels having a different wavelength, where N≧M; and
a multiplexer for providing a wavelength division multiplexed (WDM) optical signal comprising at least the N optical channels.

9. The apparatus of claim 8 wherein the spreading element comprising a Fourier transform element for spreading the information conveyed by each of the M optical signals among the N optical signals.

10. The apparatus of claim 8 wherein the multiplexer multiplexes the N optical channels, representing the information spread from the M optical channels, and K optical signals, each of the K channels representing information conveyed at a particular wavelength to provide a wavelength division multiplexed signal comprising N plus K channels.

11. The apparatus of claim 8 further comprising an optical-to-electrical converter for converting the M optical signals to M electrical signals before processing by the spreading element.

12. The apparatus of claim 11 wherein the spreading element processes the M electrical signals using a Fourier transform-based operation for spreading the information conveyed by each of the M optical signals among N electrical signals, each of the N electrical signals corresponding to one of the N optical signals, and wherein the spreading element further comprises an electrical-to-optical converter for converting the N electrical signal into the N optical signals.
